(19) United States
(12) Patent Application Publication
(10) Pub. No.: US 2023/0294342 A1
(43) Pub. Date: Sep. 21, 2023

(54) CLEANING ROLL

(71) Applicants: Christian KLAPPER, Reichshof (DE); Raimund Schauf-Ising, Kreuztal-Oberhees (DE)

(72) Inventors: Christian KLAPPER, Reichshof (DE); Raimund Schauf-Ising, Kreuztal-Oberhees (DE)

(21) Appl. No.: 18/111,248

(22) Filed: Feb. 17, 2023

(30) Foreign Application Priority Data
Mar. 15, 2022 (DE) 102022105964.2

(51) Int. Cl. B29C 45/16; A47L 9/04

(52) U.S. Cl. CPC B29C 45/1671; B29C 45/1615; A47L 9/0477; B29L 2031/7406

(57) ABSTRACT

A method of making a cleaning-roll body having a core and a jacket on the core. The method has the steps of forming the core of a first polymer by injection molding in a first injection mold, removing the injection molded from the first mold, inserting the formed core into a second mold and overmolding the jacket on the formed core.

### FIELD OF THE INVENTION

The present invention relates to a cleaning roll. More particularly this invention concerns a cleaning roll for use in a vacuum or floor scrubber.

### BACKGROUND OF THE INVENTION

A typical cleaning roll normally comprises a roll body and a cleaning element carried on it. Such a cleaning roll is normally rotated about its axis while it is moved along a floor or the like to clean it. Normally a drive rotates the roll body and its element about an axis, although oscillating movement is also possible. The roll body is responsible for the structural cohesion of the cleaning roll and its shape, while the cleaning element is provided for contact with a surface to be cleaned and thereby effects the actual cleaning action.

The cleaning element may be a cloth, fabric and/or nonwovens wrap or sleeve carried on the core. Furthermore also liquid holding structures such as sponges or foams or liquid removing elements such as sealing lips are known. A further frequent embodiment comprises structures with projecting free fiber ends or loops such as for example plush or bristle strips. Such cleaning elements can also be combined with each other to form the cleaning element.

A frequent application is cleaning rolls in floor cleaning devices such as for example vacuum cleaner nozzles, brush attachments or vacuum-cleaning robots. They have the task, in particular with textile floor coverings, of picking up adhering and/or embedded dirt particles, so that these can be carried by a suction air flow and/or by action of a cleaning liquid.

US 2004/0010875 A1 discloses a process of making a cleaning roll in which a metallic axle is overmolded with plastic. DE 10 2015 102 610 A1 shows a brush roll with a core coated with a polymeric protective layer.

The structural support part formed by the core is usually made of plastic for cost reasons. This plastic part is typically injection molded. Here, the mold is tubular and is filled with a plastic melt.

Due to the large mechanical loads in a cleaning roll, the cores must have a certain size and mass. However, this complicates the manufacture with injection molding. The large polymer mass causes too rapid and/or too unequal cooling of the polymer to form stresses and/or deformation in the molded plastic part. These affect not only the external appearance, but can also disrupt the function of the cleaning roll.

In addition to a degradation of the structural integrity due to intrinsic stresses or possibly stress cracks, a thus deformed cleaning roll may also be inefficient during operation. The irregularities can lead to an uneven weight distribution on the cleaning roll, which results in an imbalance during rotation. This in turn leads to an uneven load of the cleaning roll, its bearings and drive. It also causes imbalances during use in the form of a vibration that can be irritating for a user.

In order to avoid temperature-related distortion in large-volume injection molded parts, particularly uniform or slow cooling is required. However, this results in longer cycle times that can make production increasingly unprofitable.

### OBJECTS OF THE INVENTION

It is therefore an object of the present invention to provide an improved method of making a cleaning roll for a floor-cleaning machine.

Another object is the provision of such an improved method that overcomes the above-given disadvantages, in particular that enables an efficient manufacture of dimensionally accurate cleaning rolls.

### SUMMARY OF THE INVENTION

A method of making a cleaning-roll body having a core and a jacket on the core has according to the invention the steps of forming the core of a first polymer by injection molding in a first injection mold, removing the injection-molded core from the first mold, inserting the formed core into a second mold and overmolding the jacket on the formed core.

Thus the roll body of this invention has a core surrounded by a jacket and the roll body is produced in more than one injection-molding step. The core is produced in a first injection mold with a first polymer and the jacket is produced by at least a subsequent overmolding of the core in a second injection mold with a second polymer. By splitting the injection molding into at least two separate operations, the total mass of polymer melt of each step can be reduced. This allows the necessary solidification or cooling to take place more quickly, without causing too large temperature differences within the component.

Overmolding refers to an injection molding process in which the overmolded component, for example the core, is placed in an injection mold, in particular the second injection mold, where it is encased in a melt, in particular of the second polymer, that subsequently solidifies. In the process, the melt preferably completely fills the space formed in the second mold between the component and the injection mold.

The core produced in the first injection molding step can in particular be actively cooled, to achieve as fast as possible the necessary solidification and temperature equalization. Active cooling can be achieved within the injection mold and/or by subsequent application of a coolant, in particular cool air. Even for the case that such active cooling causes deformations, shrinkages and/or cracks occur, they can be compensated for or filled during the production of the jacket in the second injection molding step. The roll produced according to the process of the invention can be injection molded with high quality and dimensional accuracy despite the time advantage, which for such large plastic components can normally only be achieved with a complex and lengthy cooling time during the manufacturing process.

The first injection mold and the second injection mold as well if necessary as other injection molds can be formed in a single injection mold by various different so-called “mold nests.” This makes it particularly easy to implement joint temperature control and feeding with injection molding material. During a cycle, all injection molding stages can then be carried out simultaneously in the same injection mold.

In the framework of the process according to the invention the overmolding of the jacket is carried out in a several steps with further polymers. The jacket then has at least an inner portion jacket as well as an outer portion made in a further injection molding step.

Preferably exactly a further injection molding step is provided, so that the production of the core comprises a total of three injection molding steps: core, inner jacket portion and outer jacket portion. At least the inner jacket portion and core as well as the outer jacket portion and core connect thereby directly, and in surface contact with each other.

Preferably at one or several injection-molding steps except for the outer layer of the jacket, there is an active cooling. The outer jacket layer can thereby be used for surface finishing and for compensating for any inaccuracies of the substrate formed by the core and inner layers of the jacket.

Alternatively or additionally the outer layer can be produced in several, alternatively selected second or further injection molds. By the alternative selection cores of different (outer) geometry can be made. These cores can be in particular adapted to different cleaning elements. Here for example different mountings of a bristle roll can be made. As further possibility can thereby adjustments, for example between a wet-cleaning roll, for example with sponge elements and wiping strips, and of dry-cleaning roll, for example with plush and/or bristle strips, can be made possible.

According to a preferred embodiment the composition of the first polymer is equal to at least 95 wt. % of the composition of the second polymer. In the process according to the invention it is a matter of making the roll body in several parts or in several layers, in order to compensate thereby temperature or cooling caused distortions and/or shrinkage cracks. To this end it is helpful that the first and second polymers have particularly similar physical and chemical properties. Ideally, the final product is not distinguishable from one made with higher effort and longer process time. The chemical similarity of the two polymers is also especially conducive to a good cohesion between the core and the jacket.

According to a preferred embodiment of the invention, the first polymer and/or the second polymer comprises at least 50% by weight of a polymer selected from the group consisting of polystyrene (PS), acrylonitrile-butadiene-styrene (ABS) and polypropylene (PP).

It is particularly preferred that first and the second polymer be identical and formed with the same plastic composition. In addition to the advantages for the product, this way also the structure of the plant used for carrying out the process according to the invention can be simplified. For example the feeding and/or the heating and the extruder unit for the first polymer and the second polymer can be connected together. Particularly preferably only a single extruder optionally or simultaneously supplies plastic melt to the first injection mold and/or the second injection mold.

According to a further preferred aspect of the invention the first polymer and the second polymer have the same density. This can easily be realized with identical polymers or alternatively also with different polymer blends. The use of polymers of the same density ensures that the weight distribution within the roll body is independent of the shape of the overmolded jacket. Even with a strong deformation of the core in or after the first injection molding step, there are no disadvantages regarding the position of the center of gravity and the moments of inertia of the cleaning roll. Production tolerances in the manufacture of the core can therefore lead to no unwanted imbalances of the cleaning roll.

Preferably the core undergoes a cooling phase before overmolding with the second polymer, that is when moving between the first injection mold and the second injection mold. During this, the temperature of the preformed core is further lowered, so that this can serve as an additional temperature reduction during overmolding with the second polymer cooling the second polymer.

Usually injection molded parts have a temperature of about 200° C. when leaving the mold. According to a particularly preferred variant the cooling phase is of such length and designed that the core has a surface temperature of at most 160° C., that is cooled by at least 40° C. Particularly advantageous is an outer surface temperature of the core before the second injection molding step between 145° C. and 155° C.

According to a preferred embodiment the cooling phase takes place in of the first injection mold. This part is thus cooled accordingly.

According to a further preferred embodiment the cooling phase takes place at least partly outside of the first injection mold. For this, the core can additionally be treated with a cooling medium, for example cool air. Here it is of advantage that the first injection mold not be separately cooled to effect the cooling. Also the flow of the coolant can be adjusted for cooling. Any negative side effects of a too rapid cooling can subsequently be compensated by the multistage injection molding process easily. Furthermore it is of advantage that the first injection mold be used after removal of a core for molding a further core. This increases the throughput of a production line.

An aspect of the invention consists in that the cooling of the jacket can be accelerated in the context of the process according to the invention, since the already cured and possibly cooled core can act as a heat sink and accelerate the cooling of the jacket. To optimize this aspect it is preferably provided that the first polymer of the core and the second polymer of the jacket are in a mass ratio between 1:2 and 2:1. Especially preferred is a mass ratio of 1:1 or of 1:1:1 in a three-step process has turned out.

The core is according to a preferred embodiment centered on an axis formed and has axially in the direction of the rotation axis a greater, in particular five times larger, longitudinal extension has than in the radial direction perpendicular to the center axis. The cleaning roll and/or the core body are rotation symmetrical to the center axis. Thereby the cleaning roll as a whole and the core in particular are formed in such a way that the center axis runs in each case through its center of gravity. Thus, rotation does not cause imbalances.

Preferably the core has a maximum diameter between 1.5 cm and 4 cm. With a such dimension a dimensionally accurate manufacture in a single-stage injection molding process is very difficult. Preferably the core has an axial length between 20 cm and 35 cm.

According to a preferred variant of the process, cleaning elements of the cleaning element, in particular bristles or tufts of bristles, are cast into the jacket in a form-fitting manner. Thus, the cleaning elements are fixedly anchored in the core. A later separate fastening, for example by bonding or welding is omitted.

For this, the cleaning elements are clamped in the second and/or a following injection mold and the inserted core or an intermediate jacket is overmolded simultaneously with the cleaning elements in one work step.

Preferably the core has an outer surface with centering formations thereon. The formations can be bumps or recesses and serve for rotational interlocking of the jacket on the core. The complementary interlocking formations between the jacket and the core ensure that these parts mechanically coupled rigidly with each other, even if there is no bonding between the first polymer and the second polymer.

Expediently, the first injection mold is provided before the molding of the core with at least a handling aid that, after the manufacture of the jacket, can be removed nondestructively from the core. This can in particular be a metallic bar that is embedded in the first polymer in the first injection mold. After the opening of the first injection mold, the handling aid serves for removal of the core from the mold. It also subsequently simplifies the correct centering of the core in the second injection mold. This can ensure uniform circumferential overmolding of the core with the second polymer.

After the second and if necessary further injection molding steps the handling aid can be removed nondestructively from the core, by simply being pulled out of it. It can then be reused in the manufacture of the next core. After removal of the handling aid, a hole remains in the core that is filled in a subsequent step with a polymer. For this in particular the injection mold of the last injection molding step of the jacket can be used, whereby optional openings in the injection mold are to be covered for the handling aid.

Preferably within of the process according to the invention a functional unit, for example a roller bearing, is imbedded in the core. For this in particular the core is formed with a seat is formed in which the functional unit can be fitted after the first injection molding step. Overmolding of the core with the second polymer subsequently fixes the functional unit in place such that its removal is no longer possible.

In the framework of the process according to the invention, the core is overmolded by the second polymer. After the second injection molding step the solidified second polymer surrounds the core circumferentially and preferably, however not necessarily completely. According to a particularly preferred embodiment, the core may also be partially covered by the jacket. For example the core forms at least axially accessible seats that are lined by the jacket. This can be for example a socket for an axial guide pin that is inserted into the axial end of the cleaning roll. Completely particularly preferably it is possible for at least one roller bearing to be installed through which part of the overmold extends.

It is expedient that the core carries at least a drive element, in particular a gear. This can in particular be installed after the first injection molding step, after which the drive element subsequently in the second injection molding step through the jacket is solidly anchored to the core. This is particularly expedient with drive elements spaced from axial ends of the core.

Particularly preferably the core has at least an anchor element for rotational rigid coupling with the drive element. This anchor element projects from the first polymer formed projection and thus is embedded in the core and/or can be of a nonplastic material, such as for example a metal clip or metal plate. The anchor element improves transfer of torque to the core.

The invention also relates to a cleaning roll according to the previously described manufacturing process, in particular for a vacuum-cleaner floor nozzle. The cleaning roll comprises a core and a cleaning assembly on the core. According to the invention the roll body has a core of a first polymer and a jacket directly surrounding the core of a second, in particular an identical polymer. Due to the at least two-mold manufacture, the cleaning roll according to the invention has greater stability and dimensional stability. It is therefore particularly well suited for resting strong stress and for long use.

A further aspect of the invention relates to a vacuum cleaner floor nozzle having such a cleaning roll. The vacuum cleaner nozzle has a housing with a downwardly open suction mouth and a brush chamber within the housing and adjoining the suction mouth. The cleaning roll according to the invention is in of the brush chamber and coupled to a drive that rotates the cleaning roll. The drive can be in particular be an electric motor or an air turbine. The high stability and dimensional stability of the cleaning roll as a result of the manufacturing process according to the invention enables high speeds and a good cleaning effect.

### BRIEF DESCRIPTION OF THE DRAWING

The above and other objects, features, and advantages will become more readily apparent from the following description, reference being made to the accompanying drawing in which:

FIG. 1A is a longitudinal section through the core and the first injection mold;

FIG. 1B is a side view of the core made in the first injection mold;

FIG. 1C is a perspective view of a detail of the core;

FIG. 2A is a longitudinal section through the roll body according to the invention in the second injection mold; and

FIG. 2B is a side view of the finished cleaning roll according to the invention.

### SPECIFIC DESCRIPTION OF THE INVENTION

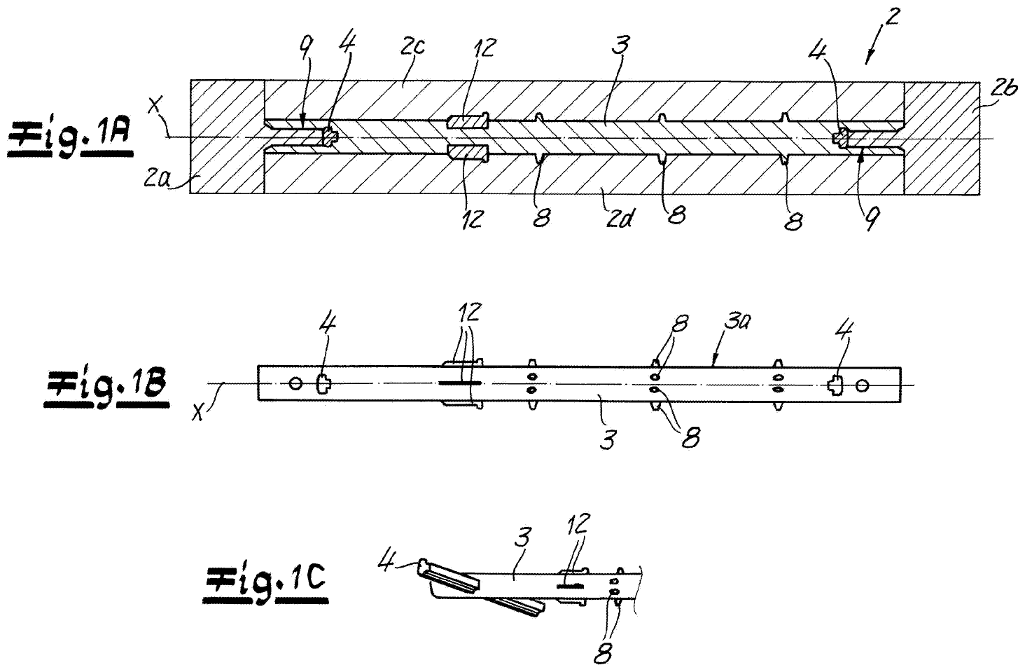

According to the process of the invention a cleaning-roll body 1 is produced in a multistage injection molding process. As can be seen from FIG. 1A a first injection mold 2 is filled with a first polymer to form a rigid core 3 constituted basically as a one-piece shaft or body of revolution centered on an axis x. The first injection mold 2 is formed in several parts, here as shown in FIG. 1A of two end pieces 2a and 2b and two side shells 2c and 2d. As handling aid for transport of the core 3 from the mold 2, ends are fitted with transverse T-section rods 4 in the mold 2. These rods 4 are secured by the polymer of the core 3 but can be removed at a later time with no harm to the core 3 by pulling out of the core 3 longitudinally of their transverse extent.

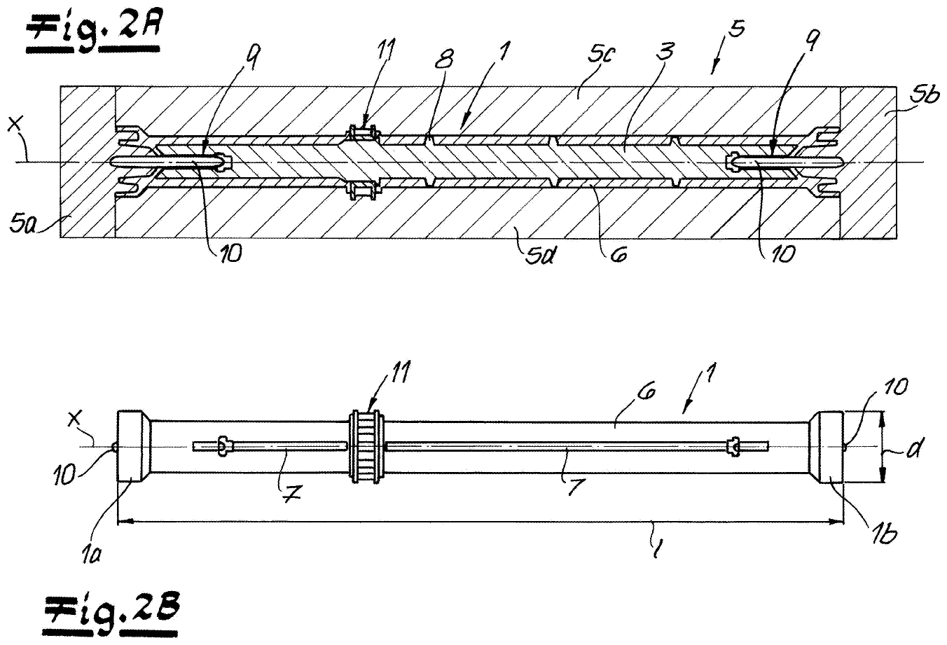

As shown in FIG. 2A the core 3 is subsequently put in a second closed mold 5 also formed of two end pieces 5a and 5b and two side shells 5c and 5d. A first polymer is injected into this mold to overmold the core 3 with a jacket 6. The sectional view shows that the jacket 6 completely externally surrounds the core 3 as shown in FIG. 2B, thereby forming the core body 1. This roll body 1 has external formations or outwardly open grooves 7 outside in which a cleaning element, for example a bristle strip, can be cemented.

To ensure good cohesion between the jacket 6 and core 3 as well as a uniform mass distribution, the core 3 and the jacket 6 are made of the same polymer, in particular of the same density. Here the mass of the jacket 6 makes up approximately two thirds of the mass of the core 3.

The roll body 1 as a whole (as well as the core 3 and the jacket 6) are bodies of revolution centered on the axis x. The roll body 1 has thereby axially, that is parallel to the axis x a longitudinal extension 1 that in is about ten times greater than the transverse dimension or diameter d perpendicular to the center axis x. Due to the rotation symmetry with respect to the x, this axis x also extends through the center of gravity of the roll body 1.

As can be seen from the FIGS. 1A and 1B the core 3 is formed on its outer surface 3a with axially and radially spaced bumps 8 that center the core 3 in the second mold 5 so the jacket is of a uniform radial thickness that is the same as the radial dimensions of the identical bumps 8.

For mounting the roll body 1 for its intended use, in particular in a vacuum-cleaner nozzle, it is provided with bearing pins that were seated in seats 9 of the end parts 5a and 5b on the axis. Thus during the overmolding step, these pins are anchored in the core 3.

FIG. 2B shows that, spaced between ends of the roll body 1 is a gear wheel 11 serving as a drive element. This is made possible in that metal plates 11 (FIGS. 1C and 2A) are embedded into the core 1 and project radially therefrom so that a metal ring gear 11 can be pushed axially over the body 1 and securely fixed on the body 1. Presuming the end pins 10 are held in bearings, a drive gear meshing with the gear 11 can rotate the entire roll body (and any cleaning element mounted thereon for instance in the grooves 7) about its axis.

We claim:

1. A method of making a cleaning-roll body having a core and a jacket on the core, the method comprising the steps of:
forming the core of a first polymer by injection molding in a first injection mold;
removing the injection molded from the first mold;
inserting the formed core into a second injection mold and overmolding the jacket on the formed core with a second polymer.

2. The method according to claim 1, wherein the composition of the first polymer corresponds to at least 95% by weight with the composition of the second polymer.

3. The method according to claim 1, wherein the first polymer is identical to the second polymer.

4. The method according to claim 1, wherein the first polymer has the same density as the second polymer.

5. The method according to claim 1, further comprising the step of:
cooling the core 3 before overmolding it with the jacket.

6. The method according to claim 1, wherein the first polymer and the second polymer are in a mass ratio between 1:2 and 2:1.

7. The method according to claim 1, the core is formed about a center axis and has an axial extent that is at least five times greater than a radial dimension of the core.

8. The method according to claim 7, wherein the axis radial dimension measured perpendicular thereto and radially of the center axis.

9. The method according to claim 7, wherein the center axis passes through a center of gravity of the core.

10. The method according to claim 7, wherein the core has a maximum diameter between 1.5 cm and 4 cm.

11. The method according to claim 7, wherein the core has a length measured parallel to the center axis of between 20 cm and 35 cm.

12. The method according to claim 1, further comprising the step of:
imbedding bristles in the jacket.

13. The method according to claim 1, wherein the core is formed in the first mold with coupling bumps extending radially into the jacket when same is overmolded on the core.

14. The method according to claim 1, further comprising the step of:
embedding a roller bearing rolling in the core in the first mold.

15. The method according to claim 7, wherein axially opposite ends of the core are formed in the first mold with axially oppositely open seats.

16. The method according to claim 1, further comprising the step before overmolding the jacket of:
fitting a drive member to the core; and
subsequently fixing the drive member on the core by overmolding of the jacket.

17. The method according to claim 1, wherein the core has anchor bodies for holding the drive member against rotation.

18. The method according to claim 1, wherein the anchor bodies are not of polymer and are embedded into the core in the first injection mold.

19. A cleaning roll comprising:
a core made of a first polymer and extending along an axis;
a jacket overmolded of a second polymer on the core, substantially surrounding the core, and adapted to carry a cleaning element.

20. A vacuum-cleaner nozzle having the cleaning roll defined in claim 18.
